(19) United States
(12) Patent Application Publication
(10) Pub. No.: US 2016/0375525 A1
(43) Pub. Date: Dec. 29, 2016

(54) Process of manufacturing fuel tank

(71) Applicant: Yu-Peng Chan, Changhua (TW)

(72) Inventor: Yu-Peng Chan, Changhua (TW)

(21) Appl. No.: 15/257,914

(22) Filed: Sep. 7, 2016

(51) Int. Cl. B23K 31/02

(52) U.S. Cl. CPC B23K 31/02; B60K 15/03006

(57) ABSTRACT

An process of manufacturing an automotive fuel tank is provided with preparing a cover formed of stainless steel, the covering including a closed edge and a space; preparing a main body formed of stainless steel, the main body including a closed edge and a space; aligning the closed edge of the cover with the closed edge of the main body; and securing the cover and the main body together by welding along the closed edges.

### BACKGROUND OF THE INVENTION

1. Field of the Invention

The invention relates to fuel tanks and more particularly to a process of manufacturing an automotive fuel tank having increased structural strength.

2. Description of Related Art

A conventional process of manufacturing an automotive fuel tank has many drawbacks and thus cracks can be caused after a period of time of use due to low structural strength thereof.

Thus, the need for improvement still exists.

### SUMMARY OF THE INVENTION

It is therefore one object of the invention to provide a process of manufacturing an automotive fuel tank, comprising the steps of preparing a cover formed of stainless steel, the covering including a closed edge and a space; preparing a main body formed of stainless steel, the main body including a closed edge and a space; aligning the closed edge of the cover with the closed edge of the main body; and securing the cover and the main body together by welding along the closed edges.

The above and other objects, features and advantages of the invention will become apparent from the following detailed description taken with the accompanying drawings.

### BRIEF DESCRIPTION OF THE DRAWINGS

FIG. 1 is an exploded view of an automotive fuel tank according to the invention;

FIG. 2 is a perspective view of the manufactured automotive fuel tank;

FIG. 3 schematically illustrates a process of manufacturing the automotive fuel tank;

FIG. 4 is an automotive fuel tank having a shape different from that shown in FIG. 2; and

FIG. 5 is another automotive fuel tank having a shape different from that shown in FIG. 2.

### DETAILED DESCRIPTION OF THE INVENTION

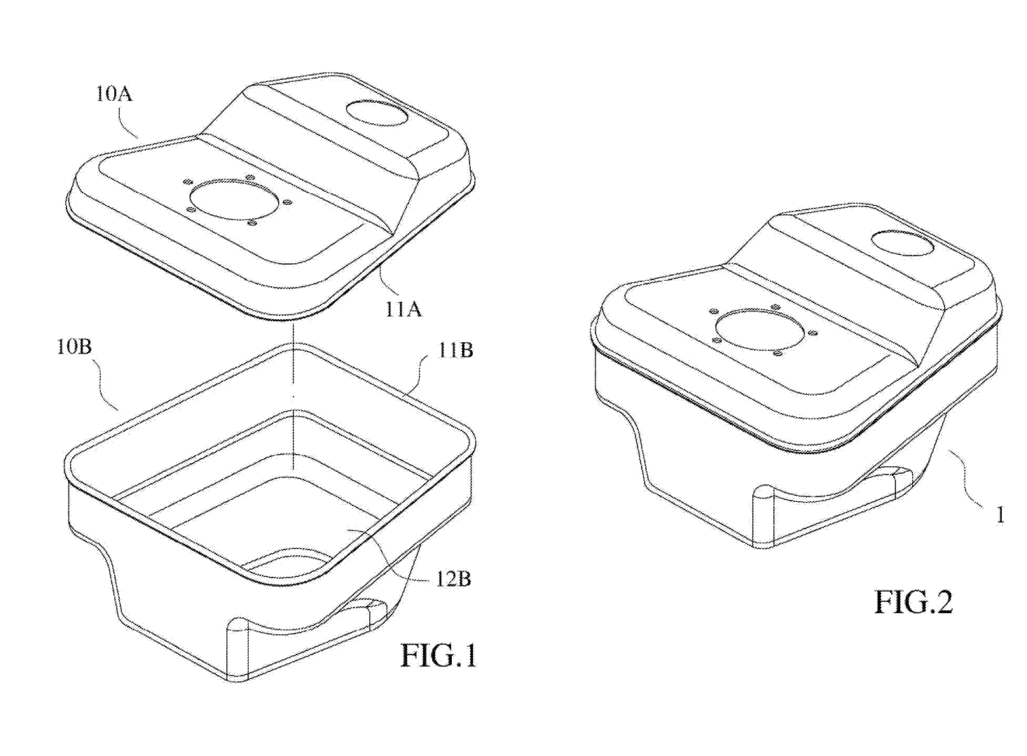

Referring to FIGS. 1 to 3, a process of manufacturing an automotive fuel tank 1 in accordance with the invention comprises the steps of preparing a cover 10A formed of stainless steel, the covering 10A including a closed edge 11A and a space 12A; preparing a main body 10B formed of stainless steel, the main body 10B including a closed edge 11B and a space 12B; aligning the closed edge 11A with the closed edge 11B; and securing the cover 10A and the main body 10B together by welding along the closed edges 11A and 11B.

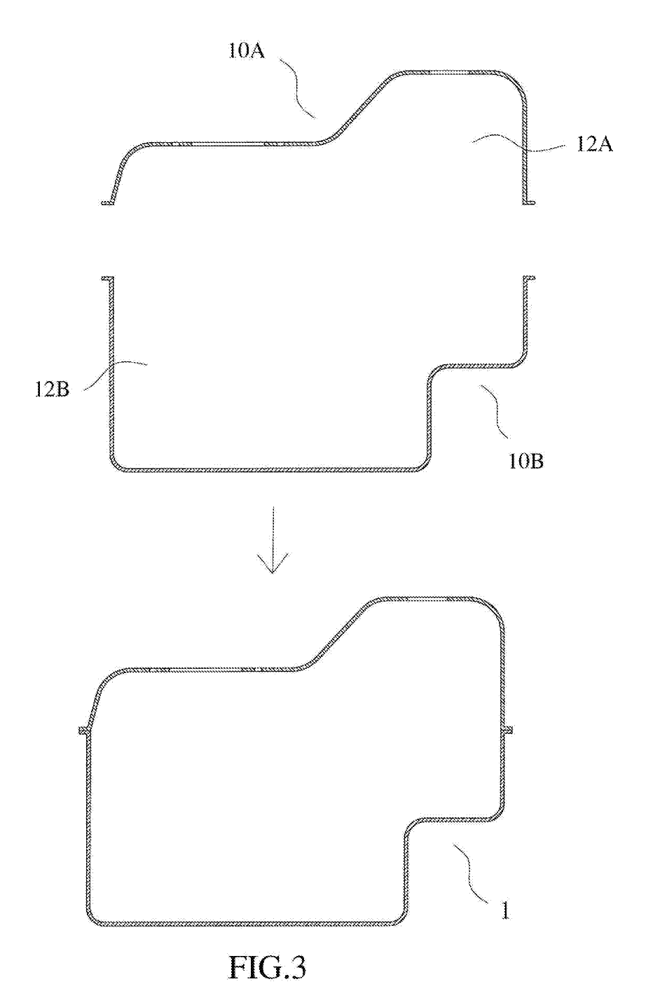

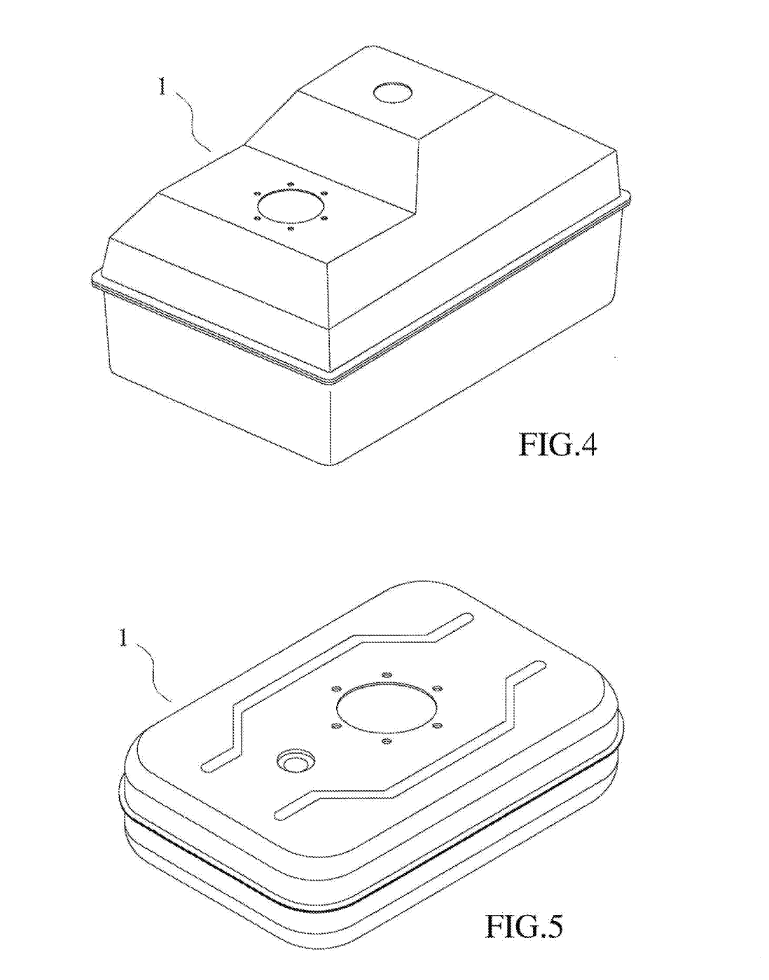

Referring to FIG. 4, an automotive fuel tank 1 having a shape different from that of FIG. 2 is shown.

Referring to FIG. 5, another automotive fuel tank 1 having a shape different from that of FIG. 2 is shown.

It is envisaged by the invention that the automotive fuel tank is structurally strong and can withstand collision without causing cracks.

While the invention has been described in terms of preferred embodiments, those skilled in the art will recognize that the invention can be practiced with modifications within the spirit and scope of the appended claims.

What is claimed is:

1. A process of manufacturing an automotive fuel tank, comprising the steps of:
preparing a cover formed of stainless steel, the covering including a closed edge and a space;
preparing a main body formed of stainless steel, the main body including a closed edge and a space;
aligning the closed edge of the cover with the closed edge of the main body; and
securing the cover and the main body together by welding along the closed edges.
